(19) United States
(12) Patent Application Publication
(10) Pub. No.: US 2017/0244530 A1
(43) Pub. Date: Aug. 24, 2017

(54) DOWNLINK LINK ADAPTATION WITH BLOCK ACKNOWLEDGEMENT FEEDBACK

(71) Applicants: Laurent Cariou, Portland, OR (US); Robert J. Stacey, Portland, OR (US)

(72) Inventors: Laurent Cariou, Portland, OR (US); Robert J. Stacey, Portland, OR (US)

(21) Appl. No.: 15/391,561

(22) Filed: Dec. 27, 2016

Related U.S. Application Data
(60) Provisional application No. 62/296,687, filed on Feb. 18, 2016.

(51) Int. Cl. H04L 5/00; H04W 72/08; H04W 72/04

(52) U.S. Cl. CPC H04L 5/0055; H04W 72/044; H04L 5/0007; H04W 72/085; H04W 72/082; H04W 84/12

(57) ABSTRACT

Methods, apparatuses, computer readable media for downlink (DL) link adaptation with block acknowledgement (BA) feedback (FB). An apparatus of an access point comprising processing circuitry is disclosed. The processing circuitry configured to encode a first downlink (DL) multi-user (MU) physical (PHY) layer convergence procedure (PLCP) protocol data unit (PPDU)(DL MU PPDU) comprising first DL resource allocations for one or more stations and first data encoded in accordance with the first DL resource allocations. The processing circuitry further configured to decode block acknowledgments (BAs) from the one or more stations, the BAs responsive to the first data and comprising link adaptations, and determine second DL resource allocations based on the link adaptations. The processing circuitry is further configured to encode a second DL MU PPDU comprising second DL resource allocations for the one or more stations and second data encoded in accordance with the second DL resource allocations, and configure the access point to transmit the second DL MU PPDU.

### PRIORITY CLAIM

This application claims the benefit of priority under 35 USC 119(e) to U.S. Provisional Patent Application Ser. No. 62/296,687, filed Feb. 18, 2016, which is incorporated herein by reference in its entirety.

### TECHNICAL FIELD

Embodiments relate to Institute of Electrical and Electronic Engineers (IEEE) 802.11. Some embodiments relate to high-efficiency (HE) wireless local-area networks (WLANs). Some embodiments relate to IEEE 802.11ax. Some embodiments relate computer readable media, methods, and apparatuses for downlink (DL) link adaptation with block acknowledgment (BA) feedback (FB).

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a BA with a link adaption field for DL link adaptation feedback in accordance with some embodiments;

FIG. 3 illustrates a link adaptation field in accordance with some embodiments;

FIG. 4 illustrates a BA in accordance with some embodiments:

FIG. 5 illustrates a DL resource allocation (RA) in accordance with some embodiments;

FIG. 6 illustrates a method for DL link adaptation with BA feedback in accordance with some embodiments;

FIG. 7 illustrates a method for DL link adaptation with BA feedback in accordance with some embodiments;

FIG. 8 illustrates a method for DL link adaptation with BA feedback in accordance with some embodiments; and

FIG. 9 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

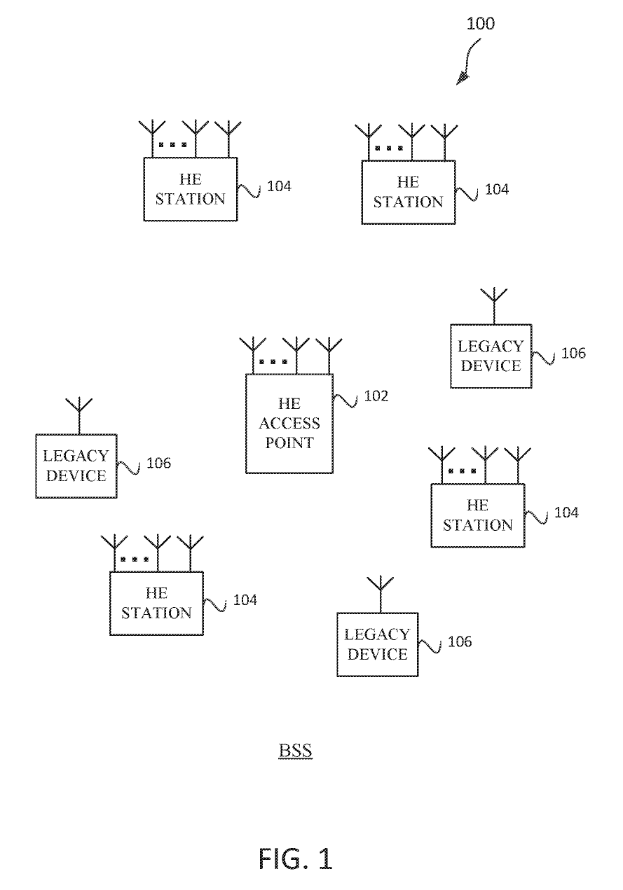

FIG. 1 illustrates a WLAN 100 in accordance with some embodiments. The WLAN 100 may comprise a BSS 100 that may include a HE access point 102, which may be an AP, a plurality of HE stations 104 (e.g., IEEE 802.11ax), and a plurality of legacy (e.g., IEEE 802.11n/ac) devices 106.

The HE access point 102 may be an AP using the IEEE 802.11 to transmit and receive. The HE access point 102 may be a base station. The HE access point 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), code division multiple access (CDMA), space-division multiple access (SDMA), and/or multiple-user multiple-input multiple-output (MU-MIMO). There may be more than one HE access point 102 that is part of an extended service set (ESS). A controller (not illustrated) may store information that is common to the more than one HE access points 102. In some embodiments, the BSS 100 may include a management entity (not illustrated), which may manage one or more BSSs. In some embodiments, the BSS 100 may include a router (not illustrated) that provides access to another network such as the Internet.

The legacy devices 106 may operate in accordance with one or more of IEEE 802.11 a/b/g/n/ac/ad/af/ah/aj/ay, or another legacy wireless communication standard. The legacy devices 106 may be stations or IEEE stations. The HE stations 104 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE stations 104 may be termed stations, HE stations, or stations (STAs).

The HE access point 102 may communicate with legacy devices 106 in accordance with legacy IEEE 802.11 communication techniques. In example embodiments, the HE access point 102 may also be configured to communicate with HE stations 104 in accordance with legacy IEEE 802.11 communication techniques.

In some embodiments, a HE frame may be configurable to have the same bandwidth as a channel. The HE frame may be a physical (PHY) layer convergence procedure (PLCP) protocol data unit (PPDU). In some embodiments, there may be different types of PPDUs that may have different fields and different physical layers and/or different media access control (MAC) layers. In some embodiments, there may be different PPDU formats for different communication standards, e.g., a non-high-throughput (HT) PPDU for IEEE 802.11a, HT PPDU for IEEE 802.11n, very HT (VHT) PPDU for IEEE 802.11ac, or HE PPDU for IEEE 802.11ax.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz. 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. 40 MHz, 80 MHz. 160 MHz, or 320 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, a 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz. 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE frame may be configured for transmitting a number of spatial streams, which may be in accordance with MU-MIMO and may be in accordance with OFDMA. In other embodiments, the HE access point 102, HE STA 104, and/or legacy device 106 may also implement different technologies such as CDMA 2000, CDMA 2000 1×, CDMA 2000 Evolution-Data Optimized (EV-DO). Interim Standard 2000 (IS-2000), Interim Standard 95 (IS-95), Interim Standard 856 (IS-856). Long Term Evolution (LTE), Global System for Mobile communications (GSM), Enhanced Data rates for GSM Evolution (EDGE). GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g, IEEE 802.11ax embodiments, a HE access point 102 may operate as a HE access point which may be arranged to contend for a wireless medium (e.g., during a contention period) to receive exclusive control of the medium for an HE control period. In some embodiments, the HE control period may be termed a transmission opportunity (TXOP). The HE access point 102 may transmit a HE trigger frame, at the beginning of the HE TXOP. The HE access point 102 may transmit a time duration of the TXOP, RU information, etc. During the HE TXOP, HE STAs 104 may communicate with the HE access point 102 in accordance with a non-contention based multiple access technique such as OFDMA or MU-MIMO. This is unlike conventional WLAN communications in which devices communicate in accordance with a contention-based communication technique, rather than a multiple access technique. During the HE TXOP, the HE access point 102 may communicate with HE stations 104 using one or more HE frames. During the HE TXOP, the HE stations 104 may operate on a channel smaller than the operating range of the HE access point 102. In some embodiments, the trigger frame may indicate one or more RUs which may be contention based for HE stations 104 and/or HE access point 102 during the TXOP. During the HE TXOP, legacy stations refrain from communicating. The legacy stations may need to receive the communication from the HE access point 102 to defer from communicating.

In accordance with some embodiments, during the HE TXOP the HE stations 104 may contend for the wireless medium with the legacy devices 106 being excluded from contending for the wireless medium during the HE TXOP. In some embodiments the trigger frame may indicate an UL MU-MIMO and/or UL OFDMA TXOP. In some embodiments, the trigger frame may include a DL MU-MIMO and/or DL OFDMA with a schedule indicated in a preamble portion of trigger frame for the HE stations 104 to decode the DL data and/or frame.

In some embodiments, the multiple-access technique used during the HE TXOP may be a scheduled OFDMA technique, although this is not a requirement. In some embodiments, the multiple access technique may be a TDMA technique, FDMA technique, SDMA, and/or CDMA.

The HE access point 102 may also communicate with legacy stations 106 and/or HE stations 104 in accordance with legacy IEEE 802.11 communication techniques. In some embodiments, the HE access point 102 may also be configurable to communicate with HE stations 104 outside the HE TXOP in accordance with legacy IEEE 802.11 communication techniques, although this is not a requirement.

In some embodiments the HE station 104 may be a “group owner” (GO) for peer-to-peer modes of operation. A wireless device may be a HE station 102 or a HE access point 102. In some embodiments, the HE station 104 and/or HE access point 102 may be configured to operate in accordance with IEEE 802.11mc. In some embodiments, one or more IEEE 802.11 communication standards may be termed WiFi®. A HE station 104 and/or HE access point 102 may be termed an HE device (e.g., station or AP), if the HE device complies with wireless communication standard IEEE 802.11ax. In some embodiments, the HE stations 104 may have limited power. In some embodiments, the HE stations 104 may have limited power and may transmit on an RU less than 20 MHz in order to reach the HE access point 104.

In example embodiments, the HE station 104 and/or the HE access point 102 are configured to perform the methods and functions described herein in conjunction with FIGS. 1-9.

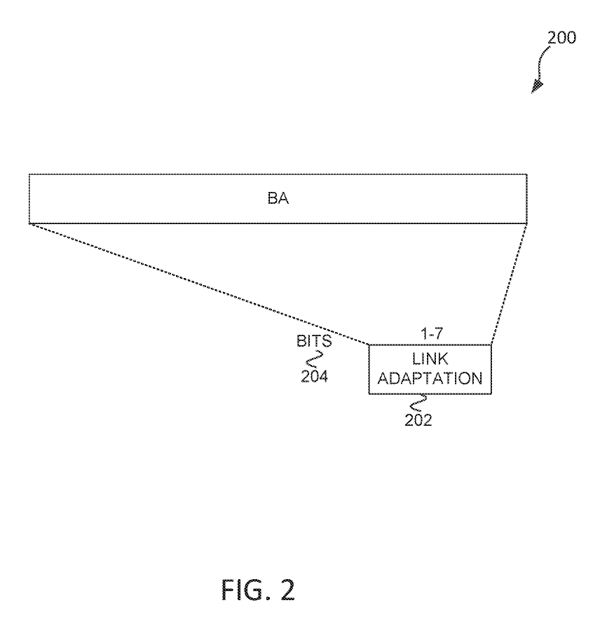

FIG. 2 illustrates a BA 200 with a link adaption 202 field for DL link adaptation feedback in accordance with some embodiments. Illustrated in FIG. 2 is a BA 200 that may include a link adaptation 202 field. The link adaptation 202 field may be one to seven bits 204 in accordance with some embodiments. In some embodiments, the link adaptation 202 field is another length. HE stations 104 may be configured to encode and transmit

The link adaptation 202 field may provide feedback to raise or lower a modulation and coding scheme (MCS). In some embodiments, a HE station 104.2 may determine to provide feedback in the link adaptation 202 field that recommends a different MCS. The HE station 104.2 may base the feedback on estimations of signal-to-noise (SNR) at different MCS levels. For example, the HE station 104 may determine that it can transmit at a higher power and encode a more rigorous MCS (e.g., a higher value for MCS). In some embodiments, the HE station 104 may determine that due to a high SNR that a less rigorous MCS (e.g., a lower value for MCS) should be used.

In some embodiments, the link adaptation 202 field may be 2 bits. Table 1 illustrates a possible encoding for 2 bits for MCS feedback. The values of link adaptation 202 field may be different (e.g, 00 may be no change and 11 may be decrease by 1). The MCS changes may indicate a different MCS value in accordance with IEEE 802.11ax, which indicates different levels of robustness for different values of MCS.

TABLE 1
2 bits encoding for MCS feedback

| Link Adaptation Value | MCS feedback |
|---|---|
| 00 | Decrease by 1 |
| 10 | No change |
| 01 | Increase by 1 |
| 11 | Increase by 2 |

The link adaptation 202 field may provide feedback to increase or decrease a number of spatial streams (SS). In some embodiments, 2 bits may be used for both MCS feedback and SS feedback. Table 2 illustrates 2 bits encoding for combined MCS and SS feedback in accordance with some embodiments. The link adaptation values may be different for the different combined MCS and SS feedback. The MCS and SS feedback may be different, e.g. decrease MCS by 1 may include decreasing SS by one spatial stream.

TABLE 2
2 bits encoding for combined MCS and SS feedback

| Link Adaptation Value | Combined MCS and SS feedback |
|---|---|
| 00 | Decrease MCS by 1 |
| 10 | Stay with current MCS |
| 01 | Increase by one MCS |
| 11 | Increase SS and use the MCS |
| | corresponding to the next higher level |

The link adaptation 202 field may provide feedback that informs an HE access point 102 that a link is dominated by interference from a signal transmitted simultaneously toward another HE station 104 that is grouped on the a same resource unit (RU). The link adaptation 202 field may provide feedback that informs an HE access point 102 that a link is dominated by interference from an external interferer. The HE access point 102 may determine to not reduce the MCS in future transmission based on the feedback because packet losses are not due to link losses, but to interference. The HE access point 102 may trigger protection for the HE station 104 (e.g., a RTS/CTS), or group the HE station 104 with other HE stations 104 associated with the HE access point 102 to reduce interference from a signal that is also transmitted from the HE access point 102.

In some embodiments, the HE access point 102 may signal to the HE access point 102 that a high portion of negative acknowledgements (NACKs) with a link adaptation 202 field value indicating not to decrease the MCS indicates that the NACKs are due to interference and not to link losses.

The link adaptation 202 field may provide feedback proposing another RU for the HE station 104.2. In some embodiments, the HE stations 104 are configured to determine based on a DL transmission (e.g., 308) from the HE access point 102 the channel on the whole bandwidth utilized by the HE access point 102. The HE stations 104 may be configured to estimate the quality of the RU the HE station 104 receives the DL transmission on, but also other RUs the HE access point 102 transmitted on. In some embodiments, if an RU or channel is better (e.g., less interference and/or less link loss), then the HE station 104 may indicate to the HE access point 102 that this RU or channel may be used instead. The HE station 104 may additionally recommend a MCS for the new RU.

In some embodiments, the link adaptation 202 field may indicate a different RU by 1 or more bits. In some embodiments, the link adaptation 202 field may indicate one of a maximum number of RUs. In some embodiments, the link adaptation 202 field may indicate a sub-band, which may be larger than the current RU, to indicate an area of the bandwidth for a new RU. For example, the link adaptation 202 field may indicate a secondary 40 MHz. The HE access point 102 may then allocate an RU in the secondary 40 MHz of approximately 5 MHz.

In some embodiments, the link adaptation 202 field may include one or more bits that split a bandwidth. For example, the link adaptation 202 field may be four bits that indicate different 5 MHz RUs of a 20 MHz channel, or different 20 MHz channels of an 80 MHz channel. The link adaptation 202 field may indicate that a different RU should be selected by the HE access point 102.

In some embodiments, the link adaptation 202 field may include two bits for a MCS feedback recommendation with SS recommendation in some embodiments and without the SS recommendation in other embodiments.

TABLE 3
2 bits for RU/sub-band selection

| Link Adaptation Value | RU/Sub-hand |
|---|---|
| 00 | First RU/Sub-band |
| 10 | Second RU/Sub-band |
| 01 | Third RU/Sub-band |
| 11 | Fourth RU/Sub-band |

Table 3 illustrates 2 bits for RU/Sub-bands. The RU/sub-bands may be the same size or may have different sizes. For example, first RU/sub-band may indicate a different 40 MHz channel, and second RU/sub-band, third RU/Sub-band, and fourth RU/sub-band may indicate a channel within a current 20 MHz channel or 40 MHz channel. In some embodiments, 3 bits may be used to indicate the feedback RU/sub-band. In some embodiments, if a feedback recommends a different RU, then a MCS feedback and/or SS (e.g., table 1 or table 2) recommendation may be for the new RU.

In some embodiments, the link adaptation 202 field is part of a BA control field of a BA 200. In some embodiments, the link adaptation 202 field is part of reserved bits of a control field of the BA 200.

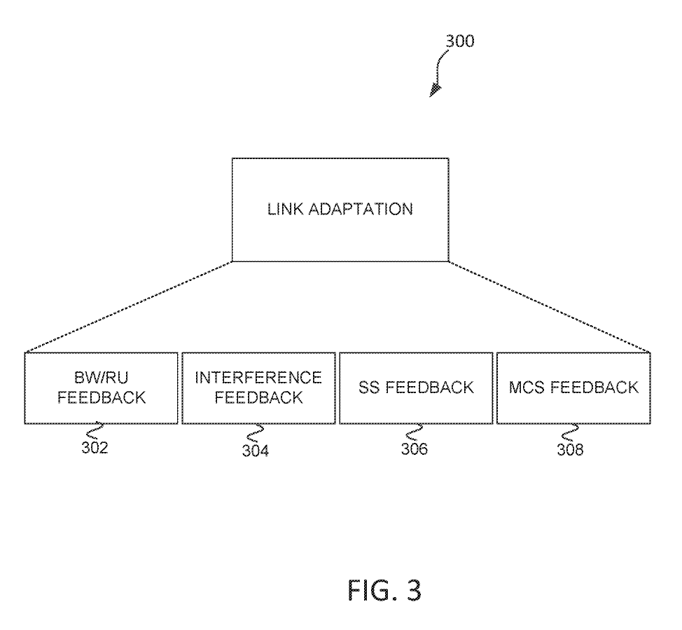

FIG. 3 illustrates a link adaptation 300 field in accordance with some embodiments. The link adaptation 300 field may include feedback, which may include one or more of BW/RU feedback 302, interference feedback 304, SS feedback, and MCS feedback 308. Although, illustrated as separate fields, the feedback may be represented by one or more fields. Examples of BW/RU feedback 302, interference feedback 304, SS feedback 306, and MCS feedback 308 are provided in conjunction with FIG. 2.

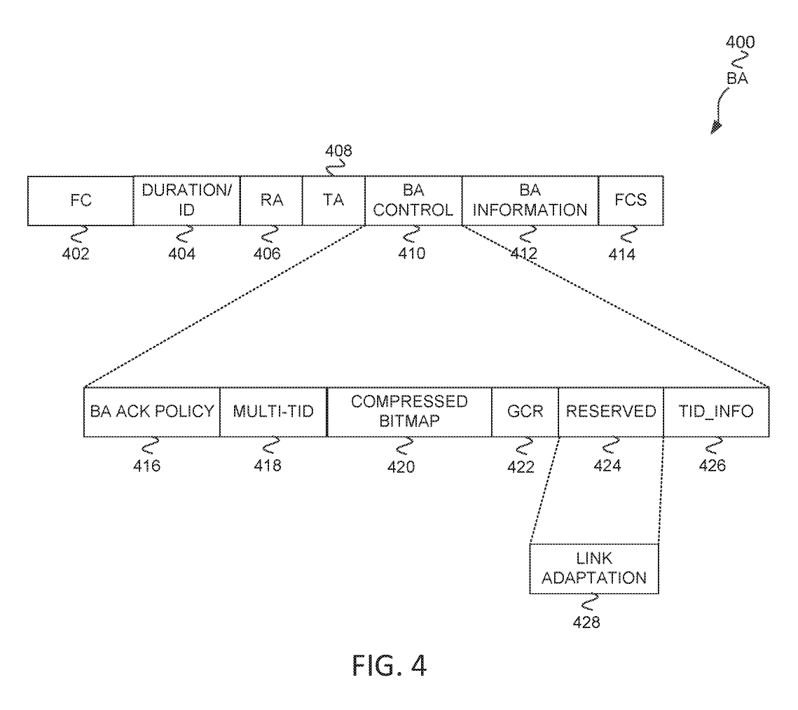

FIG. 4 illustrates a BA 400 in accordance with some embodiments. The BA 400 may include the following fields: a frame control (FC) 402, duration/ID 404, receiver address (RA) 406, transmitter address (TA) 408. BA control 410. BA information 412, and frame check sequence (FCS). The FC 410 may include information indicating the type of frame, e.g., MU-RTS, a protocol version (e.g., IEEE 802.11ax), type of frame, etc. The duration/ID 404 may be a duration of the BA 400. The RA 406 field may be an address of the recipient of the BA 400, e.g., HE access point 102. The TA 408 field may be the address of the HE station 104 transmitting the BA 400. The BA information 412 may include information for the BA. The FCS 424 may provide error correction information.

The BA control 410 may include the following fields: BA Ack policy 416, multi-traffic ID (TID) 418, compressed bitmap 420, group cast with reties (GCR) 422, reserved 424, and TID_information 428. The BA Ack policy 416 may indicate a BA policy, e.g. normal acknowledgment or no acknowledgment. The multi-TID 418, compressed bitmap 420, and GCR 422 fields determine which of the BA frame variants are represented. The GCR 422 field indicates whether the BA 400 was sent in response to a GCR BA request frame. The TID information 418 may include the number of TIDs.

The reserved 424 field may include a link adaptation 428 field. The link adaptation 428 field may be seven or fewer bits in accordance with some embodiments.

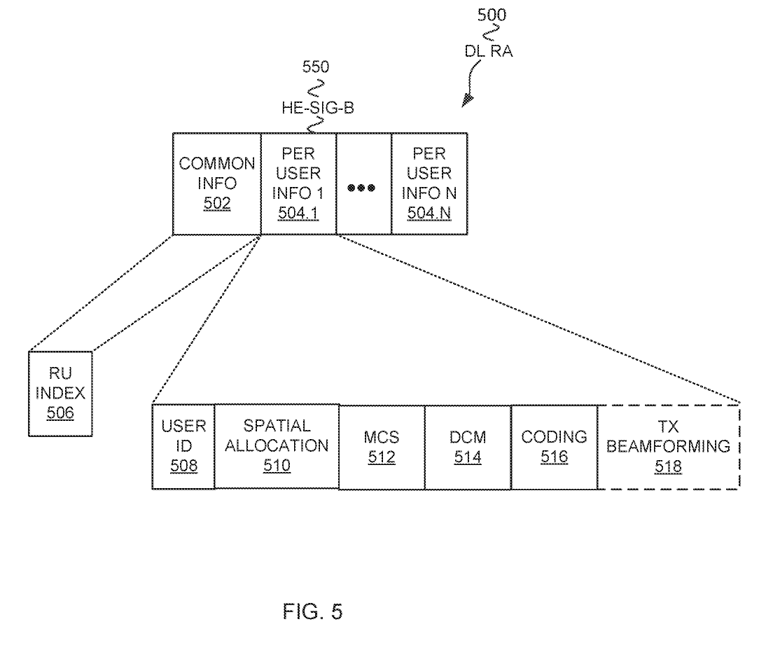

FIG. 5 illustrates a DL resource allocation (RA) 500 in accordance with some embodiments. Illustrates in FIG. 5 is DL RA 500 that includes a HE-SIG-B 550. The HE-SIG-B 550 includes common information 502, and per user information 1 504.1 through per user information N 504.N.

The common information 502 include RU index 506. The RU index 506 may be an index into a table that together with a position of the per user information 504 indicate an OFDMA RU and, optionally, with the spatially allocation 510, a spatial stream allocation. The per user information 504 may include user ID 508, spatial allocation 510. MCS 512, DCM 514, coding 516, and TX beamforming. The USER ID 508 may be an ID of the HE station 104, e.g., a pre-association or association ID. The spatial allocation 510 together with the RU index 506 may indicate a spatial stream allocation (e.g., which spatial streams and a bandwidth to transmit the spatial streams on). Dual carrier modulation (DCM) 514 indicates whether DCM is used or not. Coding 516 indicates binary convolutional coding (BCC) or low-density parity-check (LDPC) coding is used to encode the data.

TX beamforming 518 may indicate for single user mode whether or not a beamforming matrix is used to transmit the data. In some embodiments, HE-SIG-Bs 550 are transmitted separately on different 20 MHz channels. In some embodiments, data follows the HE-SIG-B 550 in accordance with the resource allocation in the HE-SIG-B 550.

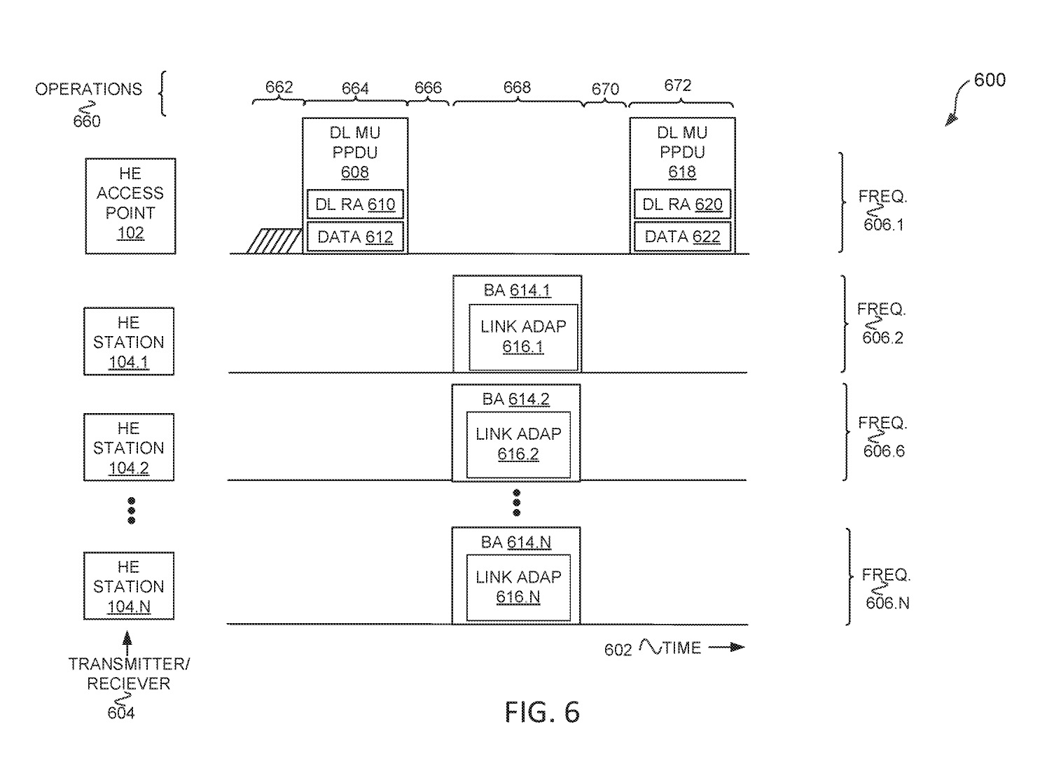

FIG. 6 illustrates a method 600 for DL link adaptation with BA feedback in accordance with some embodiments. Illustrated in FIG. 6 is time 602 along a horizontal axis, transmitter/receiver 604 along a vertical axis, frequency 606 along a vertical axis, and operations 660 along the top.

The method 600 begins at operation 662 with the HE access point 102 contending for the wireless medium. e.g., performing a CCA. The method 600 continues at operation 664 with the HE access point 102 transmitting DL MU PPDU 608. The DL MU PPDU 608 may include a DL resource allocation (RA) 610 and data 612. The DL RA 610 may be a DL RA 500 as described in conjunction with FIG. 5. The HE access point 102 may transmit the DL RA 610 first and then the data 612 in accordance with the DL RA 610. Prior to operation 664, the HE access point 102 may determine the parameters for the DL RA 610, e.g., one or more fields of DL RA 500 such as MCS 512, spatial allocation 510, RU index 506, coding 516. TX beamforming 518, and HE stations 104 (e.g., user IDs 506) to allocation DL resources to.

The HE stations 104 may receive the DL MU PPDU 608 and decode the DL RA 610 and determine their DL RA based on the DL RA 610. The HE stations 104 may then receive the data 612 in accordance with their DL RA 610. The HE stations 104 may determine one or more quality of service (QoS) parameters such as whether the DL MU PPDU 608 was received properly, whether the DL MU PPDU 608 was received with errors (which may have been corrected), a receive signal strength indicator (RSSI) of the DL MU PPDU 608, a signal to noise ratio (SNR) of the DL MU PPDU 608, etc.

The method 600 continues at operation 666 with the HE stations 104 waiting a duration (e.g., short inter-frame space. SIFS) before transmitting. In some embodiments, the HE stations 104 may perform determine whether the frequency 606 is busy during operation 666, e.g., perform a CCA and/or check one or more network allocation vectors (NAVs).

The method 600 continues at operation 668 with the HE stations 104 transmitting BA 614 to the HE access point 102. The BAs 614 may include link adaptation 616. The link adaptation 616 may be a link adaptation 202, link adaptation 300, or link adaptation 428, in accordance with the description in conjunction with FIGS. 2-4. The HE stations 104 may determine link adaptation 616 based on the reception of the DL MU PPDU 608. In some embodiments, the HE stations 104 may determine link adaptation 616 based on the reception of the DL MU PPDU 608 and one or more previous DL MU PPDUs (not illustrated). In some embodiments, the HE stations 104 may determine link adaptation 616 based on the reception of the DL MU PPDU 608 and examining other frequencies 606 other than the frequency 606 that the DL MU PPDU 608 was received on.

The method 600 continues at operation 670 with the HE access point 102 waiting a duration before transmitting. The HE access point 102 may wait a SIFS duration. The HE access point 102 may determine DL RA 620 based on link adaptation 616 and/or DL RA 610. The HE access point 102 may determine DL RA 620 based on link adaptation 616, DL RA 610, and/or reception of BA 614.

The method 600 continues at operation 672 with the HE access point 102 transmitting DL MU PPDU 618. DL MU PPDU 618 may include DL RA 620 and data 622. In some embodiments, the DL MU PPDU 618 may be received with fewer errors by the HE stations 104 due to the DL RA 620 being adapted based on the link adaptation 616. The DL MU PPDU 618 is encoded in accordance with the DL RA 620. e.g., HE long training fields and HE short training fields as well as the data 622. In some embodiments, the portion of the DL MU PPDU 618 that is encoded in accordance with the DL RA 620 begins after encoding parameters fields for an HE are transmitted, e.g., after a HE signal A (HE-SIG-A) field. The channels the DL MU PPDU 618 are transmitted on may change due to the DL RA 620 which may select different RUs for the data 622.

The method 600 may continue with additional iterations of the HE stations 104 providing link adaptations 616, and the HE access point 102 adapting DL RAs based on the link adaptations 616.

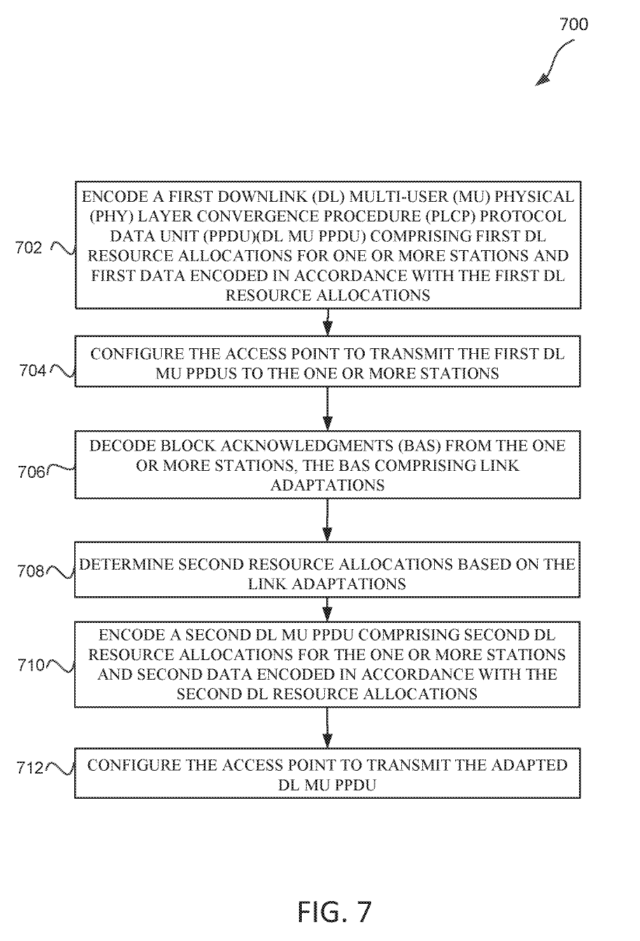

FIG. 7 illustrates a method 700 for DL link adaptation with BA feedback in accordance with some embodiments. The method 700 begins at operation 702 with encoding a first DL MU PPDU comprising first DL resource allocations for one or more stations and first data encoded in accordance with the first DL resource allocations. For example, HE access point 102 may encode DL MU PPDU 608 with DL RA 610 and data 612 as described in conjunction with FIG. 6.

The method 700 continues at operation 704 with configuring the access point to transmit the first DL MU PPDUs to the one or more stations. For example, an apparatus of the HE access point 102 may configure the HE access point 102 to transmit DL MU PPDU 608.

The method 700 continues at operation 706 with decoding BAs from the one or more stations, the BAs comprising link adaptations. For example, the HE access point 102 may decode BAs 614 comprising link adaptations 616.

The method 700 continues at operation 708 with determining second DL resource allocations based on the link adaptations. For example, HE access point 102 may determine DL RA 620 based on the linked adaptations 616.

The method 700 continues at operation 710 with encoding a second DL MU PPDU comprising second DL resource allocations for the one or more stations and second data encoded in accordance with the second DL resource allocations. For example, HE access point 102 may encode DL MU PPDU 618 with DL RA 620 and data 622.

The method 700 continues at operation 712 with configuring the access point to transmit the adapted DL MU PPDU. For example, an apparatus of the HE access point 102 may configure the HE access point 102 to transmit the DL MU PPDU 618. One or more of the operations above may be performed by an apparatus of an HE access point 102.

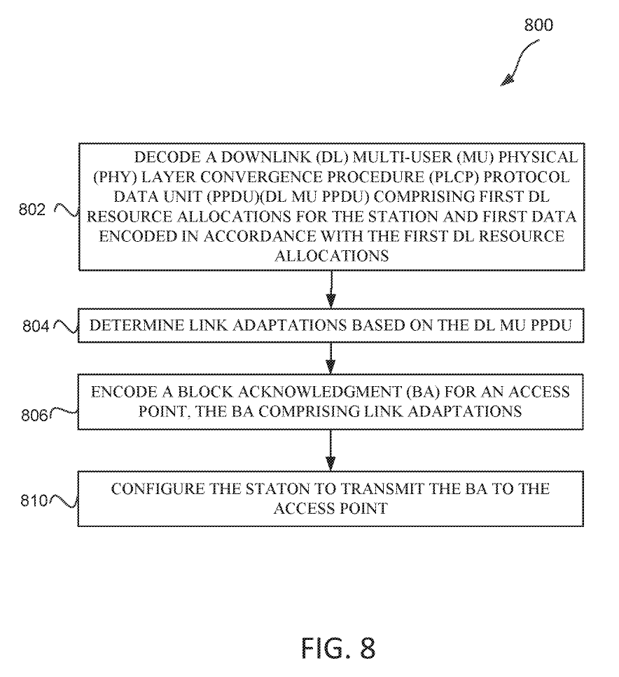

FIG. 8 illustrates a method 800 for DL link adaptation with BA feedback in accordance with some embodiments. The method 800 begins at operation 802 with decoding a DL MU PPDU comprising first DL resource allocations for the station and first data encoded in accordance with the first DL resource allocations. For example. He stations 104 may decode DL MU PPDU 608 comprising DL RA 610 and data 612.

The method 800 continues at operation 804 with determining link adaptations based on the DL MU PPDU. For example, HE stations 104 may determine link adaptations 616 based on receiving DL MU PPDU 608.

The method 800 continues at operation 806 with encoding a BA for an access point, the BA comprising link adaptations. For example, HE stations 104 may encode BAs 614 including link adaptations 616.

The method 800 continues at operation 808 with configuring the station to transmit the BA to the access point. For example, an apparatuses of the HE stations 104 may configure the HE stations 104 to transmit BAs 614. One or more of the operations above may be performed by an apparatus of a HE station 104.

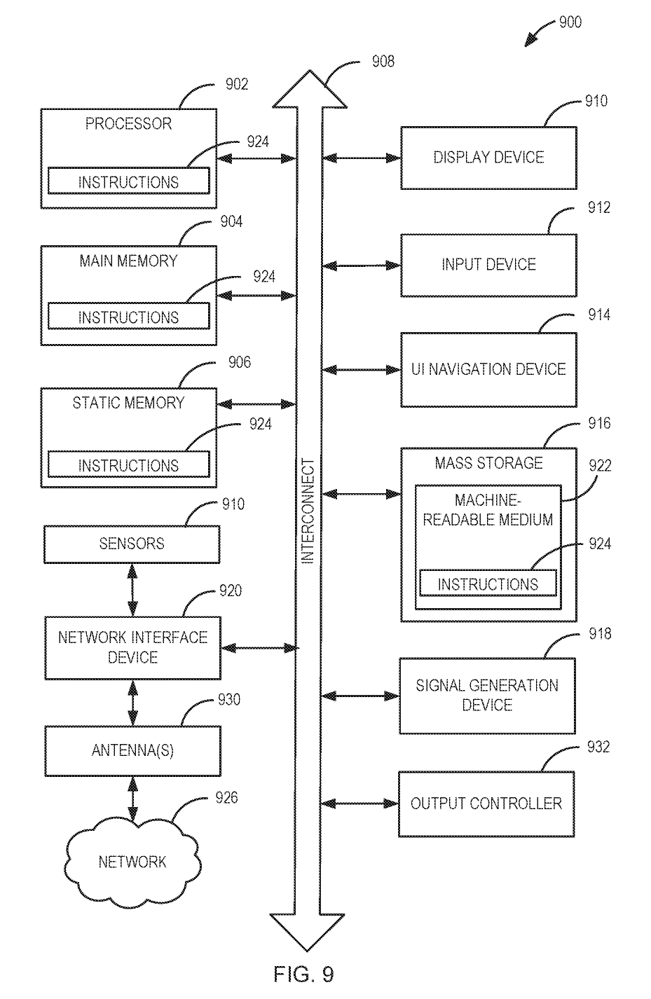

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a HE access point 102, HE station 104, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908.

Specific examples of main memory 904 include Random Access Memory (RAM), and semiconductor memory devices, which may include, in some embodiments, storage locations in semiconductors such as registers. Specific examples of static memory 906 include non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 900 may further include a display device 910, an input device 912 (e.g., a keyboard), and a user interface (UI) navigation device 914 (e.g., a mouse). In an example, the display device 910, input device 912 and UI navigation device 914 may be a touch screen display. The machine 900 may additionally include a mass storage (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 902 and/or instructions 924 may comprise processing circuitry and/or transceiver circuitry.

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 922 is illustrated as a single medium, the term “machine readable medium” may include a single medium or multiple media (e.g., a centralized or distributed database, and/or associated caches and servers) configured to store the one or more instructions 924.

An apparatus of the machine 900 may be one or more of a hardware processor 902 (e.g., a central processing unit (CPU), a graphics processing unit (GPU), a hardware processor core, or any combination thereof), a main memory 904 and a static memory 906, sensors 921, network interface device 920, antennas 960, a display device 910, an input device 912, a UI navigation device 914, a mass storage 916, instructions 924, a signal generation device 918, and an output controller 928. The apparatus may be configured to perform one or more of the methods and/or operations disclosed herein. The apparatus may be intended as a component of the machine 900 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 920 may include one or more physical jacks (e.g., Ethernet, coaxial, or phone jacks) or one or more antennas to connect to the communications network 926. In an example, the network interface device 920 may include one or more antennas 960 to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques. The term “transmission medium” shall be taken to include any intangible medium that is capable of storing, encoding or carrying instructions for execution by the machine 900, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments. Example 1 is an apparatus of an access point, the apparatus including: a memory; and processing circuitry coupled to the memory, where the processing circuitry is configured to: encode a first downlink (DL) multi-user (MU) physical (PHY) layer convergence procedure (PLCP) protocol data unit (PPDU)(DL MU PPDU) including first DL resource allocations for one or more stations and first data encoded in accordance with the first DL resource allocations; decode block acknowledgments (BAs) from the one or more stations, the BAs responsive to the first data and including link adaptations; determine second DL resource allocations based on the link adaptations; encode a second DL MU PPDU including second DL resource allocations for the one or more stations and second data encoded in accordance with the second DL resource allocations; and configure the access point to transmit the second DL MU PPDU.

In Example 2, the subject matter of Example 1 optionally includes where the DL resource allocations comprise a modulation and coding scheme (MCS), a spatial stream allocation, and an orthogonal frequency division multiple access (OFDMA) resource unit.

In Example 3, the subject matter of any one or more of Examples 1-2 optionally include where the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

In Example 4, the subject matter of Example 3 optionally includes to the index of MCSs.

In Example 5, the subject matter of any one or more of Examples 3-4 optionally include MHz channel.

In Example 6, the subject matter of any one or more of Examples 3-5 optionally include bits of the BA for the MCS recommendation.

In Example 7, the subject matter of any one or more of Examples 1-6 optionally include where the processing circuitry is further configured to: determine second resource allocations based on the link adaptations, where the link adaptations include at least one modulation and coding scheme (MCS) recommendation, and where the second resource allocations are changed in accordance with the at least one MCS recommendation.

In Example 8, the subject matter of any one or more of Examples 1-7 optionally include where the DL MU PPDU comprises one or more high efficiency (HE) signal B field including the DL resource allocation.

In Example 9, the subject matter of any one or more of Examples 1-8 optionally include where the processing circuitry is further configured to: determine second resource allocations based on the link adaptations, where the link adaptations include at least one modulation and coding scheme (MCS) recommendation and at least one spatial stream recommendation, and where the second resource allocations are changed in accordance with the at least one MCS recommendation and the at least one spatial stream recommendation.

In Example 10, the subject matter of any one or more of Examples 1-9 optionally include where the link adaptations comprise a modulation and coding scheme (MCS) recommendation, a spatial stream allocation recommendation, and an interference recommendation.

In Example 11, the subject matter of Example 10 optionally includes where the interference recommendation is one of the following group: an indication that there is interference from another station receiving transmissions from the DL MU PPDU and interference from a wireless device not receiving transmissions from the DL MU PPDU.

In Example 12, the subject matter of any one or more of Examples 1-11 optionally include ax station.

In Example 13, the subject matter of any one or more of Examples 1-12 optionally include transceiver circuitry coupled to the memory; and, one or more antennas coupled to the transceiver circuitry.

Example 14 is a non-transitory computer-readable storage medium that stores instructions for execution by one or more processors, the instructions to configure the one or more processors to cause an apparatus of an access point to: encode a first downlink (DL) multi-user (MU) physical (PHY) layer convergence procedure (PLCP) protocol data unit (PPDU)(DL MU PPDU) including first DL resource allocations for one or more stations and first data encoded in accordance with the first DL resource allocations; decode block acknowledgments (BAs) from the one or more stations, the BAs responsive to the first data and including link adaptations; determine second DL resource allocations based on the link adaptations; encode a second DL MU PPDU including second DL resource allocations for the one or more stations and second data encoded in accordance with the second DL resource allocations and configure the access point to transmit the second DL MU PPDU.

In Example 15, the subject matter of Example 14 optionally includes where the DL resource allocations comprise a modulation and coding scheme (MCS), a spatial stream allocation, and an orthogonal frequency division multiple access (OFDMA) resource unit.

In Example 16, the subject matter of any one or more of Examples 14-15 optionally include where the link adaptations including one or more of a modulation and coding scheme (MCS) recommendation, a spatial stream allocation recommendation, and an orthogonal frequency division multiple access (OFDMA) resource unit recommendation, a bandwidth recommendation and an interference recommendation.

In Example 17, the subject matter of any one or more of Examples 14-16 optionally include where the instructions further configure the one or more processors to cause an apparatus of an access point to: determine second resource allocations based on the link adaptations, where the link adaptations include at least one modulation and coding scheme (MCS) recommendation and where the second resource allocations are changed in accordance with the at least one MCS recommendation.

Example 18 is a method performed by an apparatus of an access point, the method including: encoding a first downlink (DL) multi-user (MU) physical (PHY) layer convergence procedure (PLCP) protocol data unit (PPDU)(DL MU PPDU) including first DL resource allocations for one or more stations and first data encoded in accordance with the first DL resource allocations; decoding block acknowledgments (BAs) from the one or more stations, the BAs responsive to the first data and including link adaptations; determining second DL resource allocations based on the link adaptations; encoding a second DL MU PPDU including second DL resource allocations for the one or more stations and second data encoded in accordance with the second DL resource allocations; and configuring the access point to transmit the second DL MU PPDU.

In Example 19, the subject matter of Example 18 optionally includes where the DL resource allocations comprise a modulation and coding scheme (MCS), a spatial stream allocation, and an orthogonal frequency division multiple access (OFDMA) resource unit; and, where the link adaptations including one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

Example 20 is an apparatus of a station including: a memory; and processing circuitry couple to the memory, where the processing circuitry is configured to: decode a downlink (DL) multi-user (MU) physical (PHY) layer convergence procedure (PLCP) protocol data unit (PPDU)(DL MU PPDU) including first DL resource allocations for the station and first data encoded in accordance with the first DL resource allocations; determine link adaptations based on a reception of the DL MU PPDU; encode a block acknowledgment (BA) for an access point, the BA responsive to the first data and including link adaptations; and configure the station to transmit the BA to the access point.

In Example 21, the subject matter of Example 20 optionally includes where the processing circuitry is further configured to: determine link adaptations based on the reception of the DL MU PPDU, where the reception is determined based on one or more of the following group: a received signal strength indicator (RSSI) of the DL MU PPDU and a signal to noise ratio (SNR) of the DL MU PPDU.

In Example 22, the subject matter of any one or more of Examples 20-21 optionally include where the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

In Example 23, the subject matter of any one or more of Examples 20-22 optionally include where the processing circuitry is further configured to: determine link adaptations based on whether another station causing interference between the station and the access point is identified in the DL MU PPDU.

In Example 24, the subject matter of any one or more of Examples 20-23 optionally include ax station.

In Example 25, the subject matter of any one or more of Examples 20-24 optionally include transceiver circuitry coupled to the memory; and, one or more antennas coupled to the transceiver circuitry.

Example 26 is an apparatus of an access point, the apparatus including: means for encoding a first downlink (DL) multi-user (MU) physical (PHY) layer convergence procedure (PLCP) protocol data unit (PPDU)(DL MU PPDU) including first DL resource allocations for one or more stations and first data encoded in accordance with the first DL resource allocations; means for decoding block acknowledgments (BAs) from the one or more stations, the BAs responsive to the first data and including link adaptations; means for determining second DL resource allocations based on the link adaptations; means for encoding a second DL MU PPDU including second DL resource allocations for the one or more stations and second data encoded in accordance with the second DL resource allocations; and means for configuring the access point to transmit the second DL MU PPDU.

In Example 27, the subject matter of Example 26 optionally includes where the DL resource allocations comprise a modulation and coding scheme (MCS), a spatial stream allocation, and an orthogonal frequency division multiple access (OFDMA) resource unit.

In Example 28, the subject matter of any one or more of Examples 26-27 optionally include where the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

In Example 29, the subject matter of Example 28 optionally includes to the index of MCSs.

In Example 30, the subject matter of any one or more of Examples 28-29 optionally include MHz channel.

In Example 31, the subject matter of any one or more of Examples 28-30 optionally include bits of the BA for the MCS recommendation.

In Example 32, the subject matter of any one or more of Examples 28-31 optionally include where the apparatus further comprises: means for determining second resource allocations based on the link adaptations, where the link adaptations include at least one modulation and coding scheme (MCS) recommendation, and where the second resource allocations are changed in accordance with the at least one MCS recommendation.

In Example 33, the subject matter of any one or more of Examples 28-32 optionally include where the DL MU PPDU comprises one or more high efficiency (HE) signal B field including the DL resource allocation.

In Example 34, the subject matter of any one or more of Examples 28-33 optionally include where the apparatus further comprises: means for determining second resource allocations based on the link adaptations, where the link adaptations include at least one modulation and coding scheme (MCS) recommendation and at least one spatial stream recommendation, and where the second resource allocations are changed in accordance with the at least one MCS recommendation and the at least one spatial stream recommendation

In Example 35, the subject matter of any one or more of Examples 28-34 optionally include where the link adaptations comprise a modulation and coding scheme (MCS) recommendation, a spatial stream allocation recommendation, and an interference recommendation.

In Example 36, the subject matter of Example 35 optionally includes where the interference recommendation is one of the following group: an indication that there is interference from another station receiving transmissions from the DL MU PPDU and interference from a wireless device not receiving transmissions from the DL MU PPDU.

In Example 37, the subject matter of any one or more of Examples 28-36 optionally include ax station.

In Example 38, the subject matter of any one or more of Examples 28-37 optionally include means for processing radio frequency signals coupled to a means for storing and retrieving data; and, means for transmitting and receiving the radio frequency signals.

Example 39 is a non-transitory computer-readable storage medium that stores instructions for execution by one or more processors, the instructions to configure the one or more processors to cause an apparatus of a station to: decode a downlink (DL) multi-user (MU) physical (PHY) layer convergence procedure (PLCP) protocol data unit (PPDU)(DL MU PPDU) including first DL resource allocations for the station and first data encoded in accordance with the first DL resource allocations; determine link adaptations based on a reception of the DL MU PPDU; encode a block acknowledgment (BA) for an access point, the BA responsive to the first data and including link adaptations; and configure the station to transmit the BA to the access point.

In Example 40, the subject matter of Example 39 optionally includes where the instructions further configure the one or more processors to cause an apparatus of an access point to: determine link adaptations based on the reception of the DL MU PPDU, where the reception is determined based on one or more of the following group: a received signal strength indicator (RSSI) of the DL MU PPDU and a signal to noise ratio (SNR) of the DL MU PPDU.

In Example 41, the subject matter of any one or more of Examples 39-40 optionally include where the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

In Example 42, the subject matter of any one or more of Examples 39-41 optionally include where the instructions further configure the one or more processors to cause an apparatus of an access point to: determine link adaptations based on whether another station causing interference between the station and the access point is identified in the DL MU PPDU.

In Example 43, the subject matter of any one or more of Examples 39-42 optionally include ax station.

Example 44 is a method performed by an apparatus of a station, the method including: decoding a downlink (DL) multi-user (MU) physical (PHY) layer convergence procedure (PLCP) protocol data unit (PPDU)(DL MU PPDU) including first DL resource allocations for the station and first data encoded in accordance with the first DL resource allocations, determining link adaptations based on a reception of the DL MU PPDU; encoding a block acknowledgment (BA) for an access point, the BA responsive to the first data and including link adaptations; and configuring the station to transmit the BA to the access point.

In Example 45, the subject matter of Example 44 optionally includes the method further including: determining link adaptations based on the reception of the DL MU PPDU, where the reception is determined based on one or more of the following group: a received signal strength indicator (RSSI) of the DL MU PPDU and a signal to noise ratio (SNR) of the DL MU PPDU.

In Example 46, the subject matter of any one or more of Examples 44-45 optionally include where the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

In Example 47, the subject matter of any one or more of Examples 44-46 optionally include the method further including: determine link adaptations based on whether another station causing interference between the station and the access point is identified in the DL MU PPDU.

In Example 48, the subject matter of any one or more of Examples 44-47 optionally include ax station.

Example 49 is an apparatus of a station, the apparatus including: means for decoding a downlink (DL) multi-user (MU) physical (PHY) layer convergence procedure (PLCP) protocol data unit (PPDU)(DL MU PPDU) including first DL resource allocations for the station and first data encoded in accordance with the first DL resource allocations; means for determining link adaptations based on a reception of the DL MU PPDU; means for encoding a block acknowledgment (BA) for an access point, the BA responsive to the first data and including link adaptations; and means for configuring the station to transmit the BA to the access point.

In Example 50, the subject matter of Example 49 optionally includes the apparatus further including: means for determining link adaptations based on the reception of the DL MU PPDU, where the reception is determined based on one or more of the following group: a received signal strength indicator (RSSI) of the DL MU PPDU and a signal to noise ratio (SNR) of the DL MU PPDU.

In Example 51, the subject matter of any one or more of Examples 49-50 optionally include where the link adaptations comprise one or more of a modulation and coding scheme (MCS) recommendation, a spatial stream allocation recommendation, and an orthogonal frequency division multiple access (OFDMA) resource unit recommendation a bandwidth recommendation, and an interference recommendation.

In Example 52, the subject matter of any one or more of Examples 49-51 optionally include the apparatus further including: means for determining link adaptations based on whether another station causing interference between the station and the access point is identified in the DL MU PPDU.

In Example 53, the subject matter of any one or more of Examples 49-52 optionally include ax station. The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point, the apparatus comprising: a memory; and processing circuitry coupled to the memory, wherein the processing circuitry is configured to:
encode a first downlink (DL) multi-user (MU) physical (PHY) layer convergence procedure (PLCP) protocol data unit (PPDU)(DL MU PPDU) comprising first DL resource allocations for one or more stations and first data encoded in accordance with the first DL resource allocations;
decode block acknowledgments (BAs) from the one or more stations, the BAs responsive to the first data and comprising link adaptations;
determine second DL resource allocations based on the link adaptations;
encode a second DL MU PPDU comprising second DL resource allocations for the one or more stations and second data encoded in accordance with the second DL resource allocations; and
configure the access point to transmit the second DL MU PPDU.

2. The apparatus of claim 1, wherein the DL resource allocations comprise a modulation and coding scheme (MCS), a spatial stream allocation, and an orthogonal frequency division multiple access (OFDMA) resource unit.

3. The apparatus of claim 1, wherein the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

4. The apparatus of claim 3, wherein the MCS recommendation comprises one or more of keep the same MCS, increase the robustness of the MCS by adding 1 to an index of MCSs, and decrease the robustness of the MCS by subtracting 1 to the index of MCSs.

5. The apparatus of claim 3, wherein the bandwidth recommendation comprises one of switch to an another orthogonal frequency division multiple access (OFDMA) resource unit (RU) within a same 20 MHz channel, or switch to another 20 MHz channel.

6. The apparatus of claim 3, wherein the link adaptations comprise 2 bits of the BA for the MCS recommendation.

7. The apparatus of claim 1, wherein the processing circuitry is further configured to:
determine second resource allocations based on the link adaptations, wherein the link adaptations include at least one modulation and coding scheme (MCS) recommendation, and wherein the second resource allocations are changed in accordance with the at least one MCS recommendation.

8. The apparatus of claim 1, wherein the DL MU PPDU comprises one or more high efficiency (HE) signal B field comprising the DL resource allocation.

9. The apparatus of claim 1, wherein the processing circuitry is further configured to:
determine second resource allocations based on the link adaptations, wherein the link adaptations include at least one modulation and coding scheme (MCS) recommendation and at least one spatial stream recommendation, and wherein the second resource allocations are changed in accordance with the at least one MCS recommendation and the at least one spatial stream recommendation.

10. The apparatus of claim 1, wherein the link adaptations comprise a modulation and coding scheme (MCS) recommendation, a spatial stream allocation recommendation, and an interference recommendation.

11. The apparatus of claim 10, wherein the interference recommendation is one of the following group: an indication that there is interference from another station receiving transmissions from the DL MU PPDU and interference from a wireless device not receiving transmissions from the DL MU PPDU.

12. The apparatus of claim 1, wherein the one or more stations and the access point are each one or more from the following group: an Institute of Electrical and Electronic Engineers (IEEE) 802.11ax access point, an IEEE 802.11 station, an IEEE access point, a station acting as a group owner (GO), IEEE 802.11az station, IEEE 802.11az access point, and an IEEE 802.11ax station.

13. The apparatus of claim 1, further comprising transceiver circuitry coupled to the memory; and, one or more antennas coupled to the transceiver circuitry.

14. A non-transitory computer-readable storage medium that stores instructions for execution by one or more processors, the instructions to configure the one or more processors to cause an apparatus of an access point to:
encode a first downlink (DL) multi-user (MU) physical (PHY) layer convergence procedure (PLCP) protocol data unit (PPDU)(DL MU PPDU) comprising first DL resource allocations for one or more stations and first data encoded in accordance with the first DL resource allocations;
decode block acknowledgments (BAs) from the one or more stations, the BAs responsive to the first data and comprising link adaptations;
determine second DL resource allocations based on the link adaptations;
encode a second DL MU PPDU comprising second DL resource allocations for the one or more stations and second data encoded in accordance with the second DL resource allocations; and
configure the access point to transmit the second DL MU PPDU.

15. The non-transitory computer-readable storage medium of claim 14, wherein the DL resource allocations comprise a modulation and coding scheme (MCS), a spatial stream allocation, and an orthogonal frequency division multiple access (OFDMA) resource unit.

16. The non-transitory computer-readable storage medium of claim 14, wherein the link adaptations comprising one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

17. The non-transitory computer-readable storage medium of claim 14, wherein the instructions further configure the one or more processors to cause an apparatus of an access point to:
determine second resource allocations based on the link adaptations, wherein the link adaptations include at least one modulation and coding scheme (MCS) recommendation, and wherein the second resource allocations are changed in accordance with the at least one MCS recommendation.

18. A method performed by an apparatus of an access point, the method comprising:
encoding a first downlink (DL) multi-user (MU) physical (PHY) layer convergence procedure (PLCP) protocol data unit (PPDU)(DL MU PPDU) comprising first DL resource allocations for one or more stations and first data encoded in accordance with the first DL resource allocations;
decoding block acknowledgments (BAs) from the one or more stations, the BAs responsive to the first data and comprising link adaptations;
determining second DL resource allocations based on the link adaptations;
encoding a second DL MU PPDU comprising second DL resource allocations for the one or more stations and second data encoded in accordance with the second DL resource allocations; and
configuring the access point to transmit the second DL MU PPDU.

19. The method of claim 18, wherein the DL resource allocations comprise a modulation and coding scheme (MCS), a spatial stream allocation, and an orthogonal frequency division multiple access (OFDMA) resource unit; and, wherein the link adaptations comprising one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

20. An apparatus of a station comprising: a memory; and processing circuitry couple to the memory, wherein the processing circuitry is configured to:
decode a downlink (DL) multi-user (MU) physical (PHY) layer convergence procedure (PLCP) protocol data unit (PPDU)(DL MU PPDU) comprising first DL resource allocations for the station and first data encoded in accordance with the first DL resource allocations;
determine link adaptations based on a reception of the DL MU PPDU;
encode a block acknowledgment (BA) for an access point, the BA responsive to the first data and comprising link adaptations; and
configure the station to transmit the BA to the access point.

21. The apparatus of claim 20, wherein the processing circuitry is further configured to:
determine link adaptations based on the reception of the DL MU PPDU, wherein the reception is determined based on one or more of the following group: a received signal strength indicator (RSSI) of the DL MU PPDU and a signal to noise ratio (SNR) of the DL MU PPDU.

22. The apparatus of claim 20, wherein the link adaptations comprise one or more of a modulation and coding scheme (MCS) recommendation, a spatial stream allocation recommendation, and an orthogonal frequency division multiple access (OFDMA) resource unit recommendation, a bandwidth recommendation, and an interference recommendation.

23. The apparatus of claim 20, wherein the processing circuitry is further configured to:
determine link adaptations based on whether another station causing interference between the station and the access point is identified in the DL MU PPDU.

24. The apparatus of claim 20, wherein the station and the access point is one from the following group: an Institute of Electrical and Electronic Engineers (IEEE) 802.11ax access point, an IEEE 802.11 station, an IEEE access point, a station acting as a group owner (GO), and an IEEE 802.11ax station.

25. The apparatus of claim 20, further comprising transceiver circuitry coupled to the memory; and, one or more antennas coupled to the transceiver circuitry.
